(19) United States
(12) Patent Application Publication
(10) Pub. No.: US 2012/0046794 A1
(43) Pub. Date: Feb. 23, 2012

(54) Intelligent DC Power Management System

(75) Inventors: Paul M. Altimore, Port Matilda, PA (US); Robin L. Reese, State College, PA (US); John W. Sienicki, State College, PA (US)

(73) Assignee: Spectrum Control, Inc., Fairview, PA (US)

(21) Appl. No.: 13/208,279

(22) Filed: Aug. 11, 2011

Related U.S. Application Data
(60) Provisional application No. 61/372,489, filed on Aug. 11, 2010.

(51) Int. Cl. G06F 1/28; H02J 1/00; H01H 47/00

(52) U.S. Cl. 700/286; 307/113; 307/11

(57) ABSTRACT

The invention may be embodied as a system or method of controlling DC power distribution using electronic power switches (“EPSs”) are disclosed. Current sensors may be used to monitor the performance of the electronic power switches. Load systems are electrically connected to outputs of the EPSs. An acceptable output current is determined for each EPS, and the EPSs are controlled to provide those acceptable currents. Operating parameters may be provided by a remote user via a network interface. Control power may be conditioned and isolated for proper operation of the DC power management system.

### CROSS-REFERENCE TO RELATED APPLICATION

This application claims the benefit of priority to U.S. provisional patent application Ser. No. 61/372,489, filed on Aug. 11, 2010.

### BACKGROUND OF THE INVENTION

Present day power needs for vehicular, airborne, and ground-based electrical systems are growing. Traditional electro-mechanical sensors, relays, lamps, propulsion systems, and operating-status equipment are being replaced by more efficient, compact, yet higher power density converters and power distribution controllers. Consequently, typical direct current (“DC”) power levels demanded by today's power loads are approaching nearly 500 A, which creates problems with the use of large copper-conductors, and especially with thermal magnetic circuit breakers typically used for overload protection. Thermal magnetic circuit breakers have both electrical and physical limitations that restrict their usage in today's high efficiency and high reliability applications. One limitation of particular concern is their inherent higher in-circuit impedance resulting in higher power dissipation which impacts the overall efficiency. In addition, since thermal magnetic circuit breakers are a mechanical device they are large and heavy. Furthermore, they are difficult to actuate from an electronic control and/or monitoring system. Lastly, circuit breakers will mechanically wear out, and therefore require either preventive maintenance or replacement to insure reliable operation.

Typical DC power management systems utilize large enclosures constructed to house large busbar connections, large DC magnetic circuit breakers, large electro-magnetic contactors for DC power load control, current shunt resistors, and large wire connections. The use of circuit breakers and electro-mechanical relays are commonly found in devices utilized for DC power management. However, these devices are physically large and dissipate large amounts of power during normal operation.

Measuring DC current is typically accomplished by a current sensing device placed in the current path of the power circuitry. The current sensing device may be a passive device or an active device. A passive current sensing device senses current by measuring the potential difference across a resistor to obtain a proportional measure of current though the resistor by way of Ohm's law. An active current sensing device senses current by measuring the magnetic field about a current carrying conductor to obtain a proportional measure of current by way of the Hall Effect. These current sensing devices dissipate heat during normal operation. Also, there are a number of mechanical connections needed to connect these sensing devices with other parts of the circuit, and these connections introduce resistance, which could generate a sizable amount of heat.

Existing power management systems have power handling densities of about 12 watts/in³. Some systems require forced air, or liquid cooling to reliably distribute the necessary power to DC loads. The use of such cooling options requires additional power itself, and has other physical limitations.

### SUMMARY OF THE INVENTION

The invention may be implemented as a control system for distribution of direct current electricity to one or more load systems. Such a distribution system may include one or more electronic power switches (“EPSs”), each having an input terminal and an output terminal. Each EPS may be a MOSFET. Each EPS input terminal may be electrically connected to the same supply of direct current electricity.

One or more loads may be connected to the output terminals of the EPSs. As such, each EPS may control the supply of direct current electricity to a different load, or more than one EPS may be used to supply direct current electricity to the same load.

One or more current sensors may be included in the distribution system to monitor the current being supplied by each EPS. The current sensors may be active current sensors or passive current sensors. For example, a Hall-effect current sensor may be used.

The distribution system may have a micro-controller that is programmed to control operation of the EPSs. The micro-controller can be used to provide DC electric power via the EPSs to a single load system or multiple load systems, either via a single EPS or multiple EPSs. The program executed by the micro-controller may have instructions for causing the micro-controller to determine a level of DC current supplied to one or more load systems, and for causing the micro-controller to adjust the one or more EPSs in response to the determined DC current level(s).

For example, the program may cause the micro-controller to adjust the one or more EPSs during turn-on and/or turn-off of the load systems that draw power from the one or more EPSs. The EPSs may be controlled by the micro-controller to limit the current supplied to the load systems.

Adjustments made by the micro-controller may be accomplished according to user-defined parameters that are stored in a computer-readable medium that has the program stored or embedded thereon. The program may include instructions for causing the EPSs to turn on in small increments. For example, the increments may be selected to limit individual or aggregate load currents to levels which are within maximum operating parameters of the EPSs. The program may include instructions for causing the EPSs to control the EPSs so that the power supplied by each EPS to the loads at a safe level. The micro-controller can be used to sequentially power individual load systems such that high-power distribution currents typically experienced during turn-on of such load systems are reduced, or eliminated.

The DC current distribution control system may be implemented using a printed circuit board and circuit layout which lowers parasitic inductance and increases current throughput.

The invention may be implemented as a method of controlling the distribution of DC electric power. In one such method, one or more EPSs are provided. Each EPS has an input terminal and an output terminal. The input terminals may be electrically connected to one another. One or more current sensors are provided and arranged to monitor DC electric current supplied by at least one of the EPSs. A programmed microcontroller, which is in communication with the EPSs, is used to control distribution of DC electric current by adjusting the current supplied by the output of each EPS.

### BRIEF DESCRIPTION OF THE DRAWING

For a fuller understanding of the nature and objects of the invention, reference should be made to the accompanying drawings and the subsequent description. Briefly, the drawings are:

FIG. 1 is a block diagram of a DC power management system that is in keeping with the invention;

FIG. 2 depicts an interface;

FIG. 3 is a flow diagram for an algorithm that may be used in the invention; and

FIG. 4 is a flow chart of a method that is in keeping with the invention.

### DETAILED DESCRIPTION OF THE INVENTION

An intelligent DC power management system is disclosed herein. Since the embodiments shown in the drawings are for illustrative purposes, some sub-components and/or peripheral components generally incorporated in the disclosure are omitted from this description for purposes of brevity and clarity. In describing embodiments in accordance with the present invention, specific terminologies are employed for sake of clarity. However, the invention is not intended to be limited to the selected terminologies and specified embodiments described herein. It should be stressed that the invention may be embodied in many different forms, and the figures should not be construed as limiting to the particular embodiments depicted in the figures. Rather, the figures are provided to illustrate how the invention might be implemented.

The present invention relates to systems and methods for distributing and controlling DC electric power. One such a system 50 may be used to provide high efficiency (i.e. low power loss) in a battery-operated system. In particular, the invention may be used with systems commonly found on airborne or ground-based vehicles. Also, the invention may be particularly well suited for use with DC power sources such as solar-electricity generators, as well as thermal and chemical conversion devices which produce DC current, or as a voltage converter.

The invention may use a micro-controller (CPU 104) to analyze current use by the loads 400, and to control one or more EPSs 107, 109. EPSs 107, 109 are particularly well suited since their power-loss is low, they have the ability to handle a large range of power, and they are highly efficient. The EPSs 107, 109 may be MOSFETs which have been arranged electrically in parallel with one another. Such an arrangement affords better current-sharing among these devices in a reliable and compact manner. For example, the CPU 104 may be programmed to adjust one or more of the EPSs 107, 109 during turn-on and/or turn-off of loads 400 that draw power from the one or more EPSs 107, 109. Doing so may entail controlling one or more of the EPSs 107, 109 to limit the current supplied to load systems 400 associated with those EPSs 107, 109. The invention also may be implemented to facilitate the use of user-defined parameters that may be provided to the CPU 104 remotely via a user network interface 304.

The program executed by the CPU 104 may be provided via a memory device that is readable by the CPU 104. The memory device may include instructions executable by the CPU 104 to provide a default set of operating instructions, and/or the memory device may be programmable so that special operating characteristics may be realized. For example, the program may include instructions for causing the CPU 104 to control the EPSs 107, 109 in order to keep the power supplied by each EPS 107, 109 at a safe level. To illustrate, in order to start supplying electricity to one of the loads 400, the CPU 104 may be programmed to cause one of the EPS 107, 109 to turn on in small increments so that other loads 400 do not experience a sudden drop in electricity. Also, the increments may be selected to limit individual or aggregate load current to levels that do not exceed maximum operating parameters of the EPSs 107, 109.

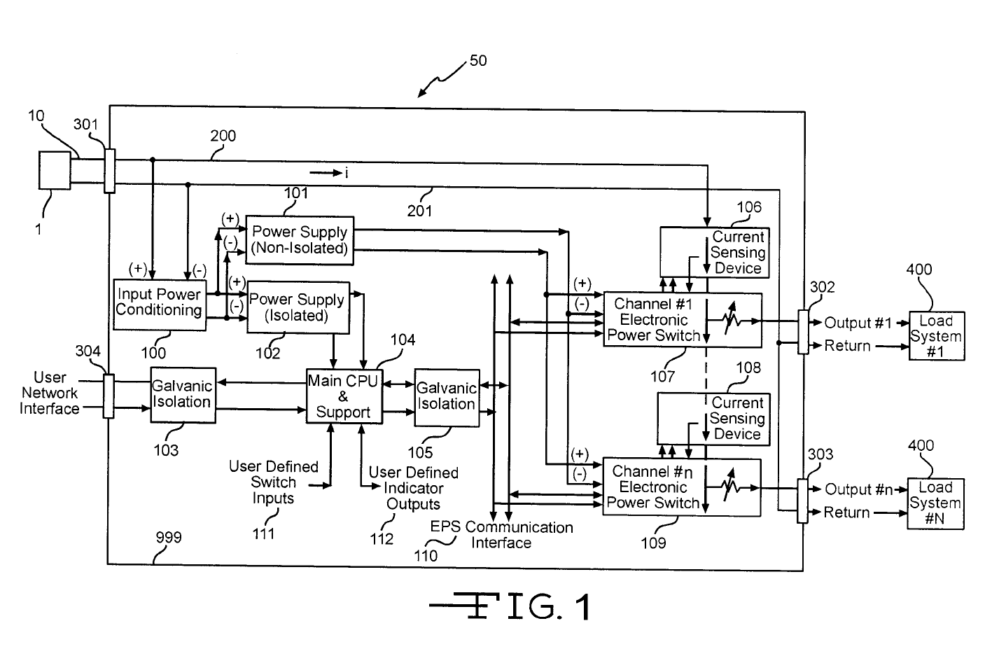

FIG. 1 is a general block diagram and schematic representation of an intelligent DC power management system 50 according to one embodiment of the present invention. The system line voltage (+) 10 may be connected to a space/weight efficient connector system (not shown), whose objective is to provide low resistance connections in order to reduce loss of power being delivered to the load, which can be internally connected via low-loss conductor 200 to one or more low loss, solid-state current sensors 106, 108. As used herein, the term “low loss” means a low resistance material or device that is either the primary current conductor or measurement device inserted in the primary conductor path. Being “low loss” the material or device provides a higher level of efficiency, which translates into improved performance of the system that employs such a material or device. The current sensors 106, 108 may be active or passive current sensors, or a combination of these. As an example, the current sensor may be an Allegro Micro-Systems Model ACS758.

The current sensors 106, 108 may interpret and transmit information about the current being handled to one or more EPSs 107, 109. For example, the current information may be the amperage being supplied to the load systems 400. In FIG. 1, current sensor 106 communicates information to the EPS 107. Similarly in FIG. 1, the current sensor 108 communicates information to the EPS 109.

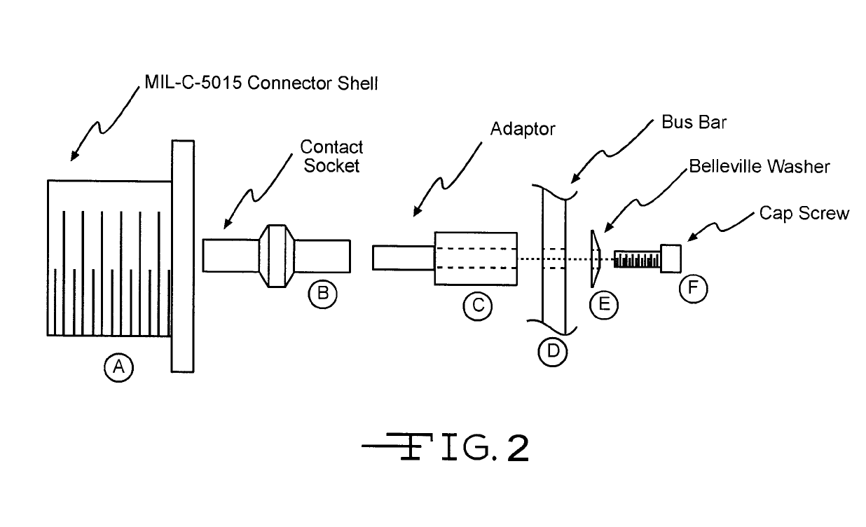

External power source 1 may be connected to the DC power management system 50 by an interface 301. FIG. 2 depicts an interface 301 that may be used in the invention. The interface 301 depicted in FIG. 2 is a ruggedized circular connector (A) which incorporates a socket contact(s) (B) for attachment of a conductor. A highly conductive (e.g. OFHC, CA101) adaptor (C) may be designed to fit into the socket contact (B) where it is metallurgically bonded to (B). This adaptor provides a highly conductive land area for attachment to a bus-bar (D) using a cone-shaped washer (E) and machined screw fastener (F) for near constant force loading of conductive surfaces. This combination, together with an appropriate amount of anti-oxidant compound, provides a low resistance connection that is superior to that which can be provided by a conventional wire connection to the socket contact(s).

Input power conditioning device 100 may provide protective and mitigating capability in order to guard against unwanted disturbances from the power source 1 reaching components of the distribution system 50. A first power supply 101 may provide a regulated voltage for powering the operation of the current sensors 106, 108 and EPSs 107, 109. A second power supply 102 may provide a voltage that is isolated from the system line 10 voltage for providing power necessary to operate a main central processing unit (“CPU”) 104. In this manner, differing power requirements of the EPSs 107, 109 and the CPU 104 may be accommodated.

The main CPU 104 may communicate with each EPS 107, 109 via an EPS 107, 109 communication interface 110 in order to implement operational parameters desired by a user, and provide operational commands for each EPS 107, 109 to control operation of the EPS 107, 109. The CPU 104 preferably has built-in core functions like adequate Flash memory, RAM, Serial I/O, GP I/O, and multi-channel 12-bit A/D converters. In addition, each EPS 107, 109 may utilize the communication interface 110 to communicate information to the main CPU 104 about the operational status of the EPS 107, 109 (e.g. “on”, “off”, or “fault”), and the output conditions (e.g. current and voltage) associated with each EPS 107, 109. A galvanic isolation device 105 can provide electrical isolation between the main CPU 104 and EPSs 107, 109 so that current is prevented from reaching ground, for example, by a person's body.

The main CPU 104 may receive system operation commands via a user network interface 304. For example, the user network interface may be one which meets the standards of Ethernet IEEE 802, CAN (Controller Area Network) SAE J1939, or other standard, as required by the user. The user network interface 304 may be used to report operational status of the power management system 50, or its components, as directed by the user. Galvanic isolation device 103 may provide electrical isolation between the user network and the main CPU in order to protect the main CPU from the vagaries of the network.

Commands, including program instructions, may be provided to the main CPU 104 via the switch input 111, and in this manner inputs may be provided to the CPU 104 without using the network interface 304. Local status indications may be provided from the CPU 104 via indicator outputs 112. In this manner, a person may interact with the CPU 104 when located at the distribution system 50.

Via the switch input 111, a user may provide operating parameters and/or program code, and the system's 50 response may be provided to the user via switch output 112. In this manner, proper equipment safety, set-up, and maintenance may be accomplished locally without the need to interface via the network interface 304.

Each EPS 107, 109 may manage the application of power to equipment (“load systems”), which are connected to one of the output connections 302, 303. EPSs 107, 109 may be MOSFETs which have been arranged electrically in parallel with one another. The EPS 107, 109 adjusts the power delivered to a load by controlling the MOSFET during on and off command transitions, as well as going to an off command upon detection of a fault. When arranged in parallel, the EPSs 107, 109 may share current in a more reliable and compact manner than existing circuit breakers and relays. The EPSs 107, 109 can manage power application using an algorithm which takes into account the operational parameters provided to the main CPU 104. The algorithm may be selected to keep the output on/off profiles of the load systems 400, which are powered via the EPSs 107, 109, within prescribed operating limits. In addition, the algorithm may be used to monitor the power dissipated in the MOSFET array and provide control commands in order to maintain the MOSFET array within a predetermined safe operating parameters.

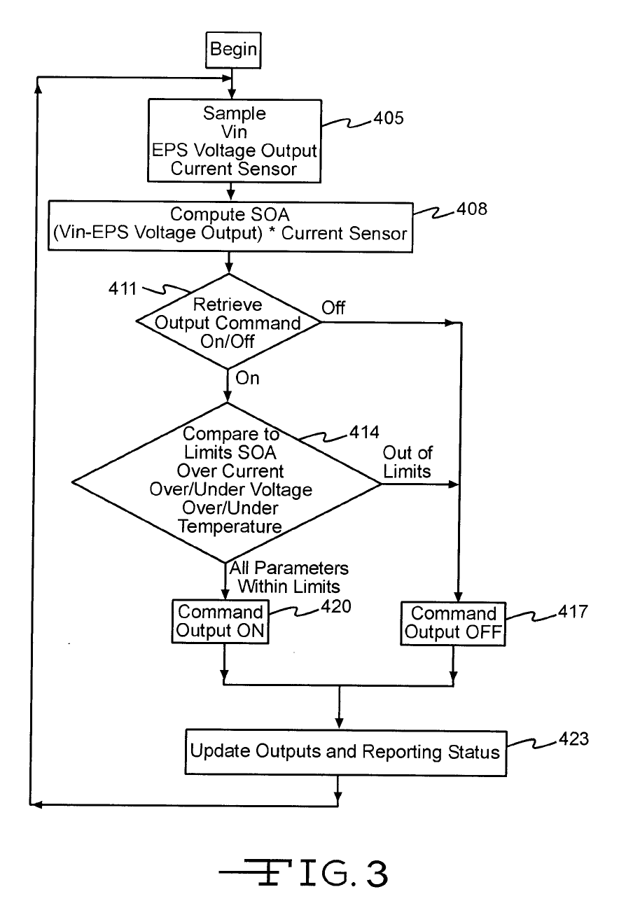

The algorithm may be accomplished by means of hardware and software in a manner that protects the load as well as the EPSs 107, 109 and the MOSFET array. For example, hardware may be used to provide fast response to a high surge overload condition, and software may be used to provide control in other situations to keep system parameters within acceptable limits and provide appropriate timing for carrying out commands, as well as dynamic configuration. For example, software may be used to control the EPS 107, 109 to maintain the current delivered to the load 400 within a safe operating limit. FIG. 3 is a flow diagram depicting such an algorithm. That algorithm measures 405 the system line voltage 10, the output voltage (voltage supplied to the load 400), the current being supplied to that load 400, and a temperature that is important to the system. For example, the temperature of a case that covers and protects the system 50 may be monitored. The SOA is computed 408, which is a parameter found by multiplying the measured current with the difference between the system line voltage 10 and the output voltage. An output command is retrieved 411, which is an indication as to whether the load should be turned on or off. If the command is to turn off, then the system provides 417 a command to turn off power being supplied to the load 400. However, if the command is to turn on, then one or more comparisons are made 414. For example, the calculated SOA may be compared to an SOA threshold, the measured current may be compared to a current threshold, the output voltage may be compared to a voltage threshold, and the measured temperature may be compared to a threshold temperature. If any of these parameters are determined to be unacceptable with respect to the threshold, a determination is made that the system is out of limits and a command is sent 417 to the relevant EPS 107, 109 instructing it to turn off. If all parameters are determined to be acceptable with respect to the threshold, then a determination is made that the system is within limits and a command is sent 420 to the relevant EPS 107, 109 instructing it to turn on. Then, the status of the system is updated 423, and the algorithm may then begin again to sample voltages and current.

The outputs 302, 303 of each EPS 107, 109 may be monitored by the current sensing devices 106, 108, and if the output exceeds desired limits, the EPSs 107, 109 may be instructed to take appropriate action to mitigate the excessive condition. For example, current supplied to a load system 400 may be reduced or turned off, and the action taken may be communicated to the main CPU 104. The main CPU 104 may then report the condition and actions to a user via the user network interface 304 for consideration by an overall system program that may be operating on a remote computer that is under the user's control.

A system 50 according to the invention may utilize air to maintain proper operating temperatures. The EPSs 107, 109 may be configured to achieve a low resistance, thereby minimizing unnecessary power dissipation while simultaneously improving operating efficiency. For example, the EPSs 107, 109 may be arranged to accomplish low resistance by paralleling MOSFET devices. When activated, MOSFET's exhibit an expected “on resistance”, but the resultant resistance is much lower when a number of MOSFET's are placed in parallel. In this manner it is possible to achieve a resistance of less than 500 micro-Ohm's, which yields reduced heat loss and improved efficiency.

Additionally, the configuration for the EPSs 107, 109 may be selected to afford an efficient means of moving heat away from the EPSs 107, 109 to a location outside the enclosure 999. In doing so, ambient air and natural convection currents may be used to move unwanted heat away from the EPSs 107, 109. In one such method of moving unwanted heat, the EPSs 107, 109 are mounted within an enclosure or chassis. For example, the EPSs 107, 109 may be mounted against the floor of the chassis by using thermal gap material to provide electrical isolation while achieving good thermal conductivity. Also, the EPSs 107, 109 may be positioned to have a short heat conduction path with regard to heat generated by the MOSFET array. Even though the generated heat from power MOSFET's are small, that heat must have an efficient path in order to move the heat away from the devices. For example, this may be accomplished by mounting the EPS 107, 109 against the wall of the enclosure that will provide the most cross-sectional surface area for heat conduction. To electrically isolate the MOSFET from the chassis, while providing a thermally conductive path, a thermal pad may be used which has excellent electrical isolation properties while high thermal conductive properties.

It will now be recognized that FIG. 1 depicts a system 50 for controlling DC power distribution in which EPS 107, 109 are used as the primary current control and distribution device. Each EPS 107, 109 has an input terminal and an output terminal, and when more than one EPS 107, 109 is provided, the input terminals may be electrically connected to one another so that the EPSs 107, 109 share a supply of power.

The amount of current supplied by each EPS 107, 109 to a load system 400 may be monitored with one or more current sensors 106, 108. In addition, the power provided by each EPS 107, 109 may be monitored. It should be noted that outlets of the EPSs 107, 109 may be connected to the same loads 400, or different loads 400. In this manner, the CPU 104 can be used to sequentially power individual load systems 400 such that high-power distribution currents typically experienced during turn-on of some load systems 400 are reduced, or eliminated.

By using the invention described herein, it is possible to create a system having 0.15-0.20 watts per square inch of surface area, thereby achieving an average external case temperature rise of 30 degrees Celsius at 100,000 feet or 20 degrees Celsius at sea level. At an average of 0.15 watts per square inch of surface area, it may be possible to achieve an average external case temperature rise of about 25 degrees Celsius. In addition, it is possible to achieve electrical efficiency of about 98.5%, or higher.

It is possible to construct a device that uses the techniques described herein that will operate within a temperature range of −40 to +71 degrees Celsius with typical operating voltage selections of +12, +24, +28, and −48Vdc.

Finally, it should be recognized that the invention allows for connecting directly to a primary power bus, without the need for intermediate input voltage conditioning. Also, the device and its protection mechanisms may be self-contained and need not require additional support apparatus. For example, such an apparatus might require additional connectivity to provide electromagnetic filtering, transient voltage suppression, voltage pre-regulators, or active clamping devices. Further, when the invention is implemented as a self-contained device, the input and output connections are directly connected to the switching devices using low loss materials and connection techniques. In addition, appropriately tight package placement using layered PCB stack-up can be used to accomplish pseudo bus-bar conductor behavior within the PCB to minimize inductance and resistance.

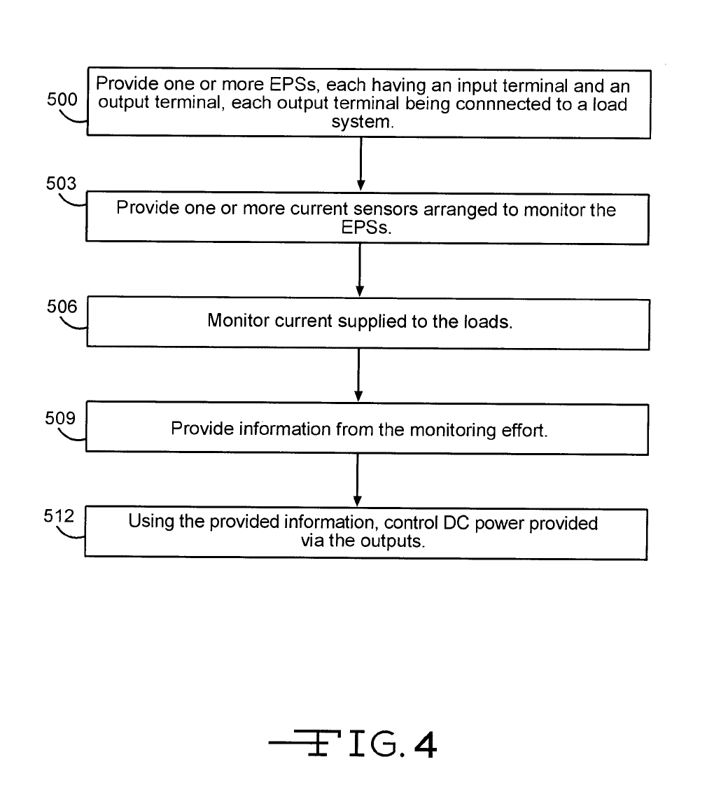

The invention may be embodied as a method of controlling the distribution of DC electric power. FIG. 4 shows steps of such a method. In one such method, one or more EPSs are provided 500. Each EPS has an input terminal and an output terminal. The input terminals may be connected to each other so that the voltage at each input terminal is approximately the same. A load system may be connected to one or more of the output terminals. Current sensors may be provided 503 to monitor DC electric current supplied by each EPS, and the current supplied to the loads may be monitored 506. Information from this monitoring effort may be provided 509. Using the provided information, DC electric current from each output terminal is controlled 512 using the EPSs, thereby affording control and distribution of the DC electric power to the connected load systems.

Although embodiments of the invention have been described herein, the invention is not limited to such embodiments. The claims which follow are directed to the invention, and are intended to further describe the invention, but are not intended to limit the scope of the invention.

What is claimed is:

1. A direct-current control and distribution system, comprising:
one or more electronic power switches (“EPSs”), each having an input terminal and an output terminal, each input terminal being electrically connected to a supply of direct current electricity; and
one or more current sensors for monitoring currents being supplied by each EPS.

2. The system of claim 1, wherein each output terminal is electrically connected to a different load.

3. The system of claim 1, wherein the EPSs are MOSFETs.

4. The system of claim 1, wherein the one or more current sensors are active current sensors.

5. The system of claim 1, wherein the one or more current sensors are passive current sensors.

6. The system of claim 5, wherein the current sensor is a Hall effect sensor.

7. The system of claim 1, further comprising a micro-controller and a program for controlling operation of the micro-controller, the program having instructions for causing the micro-controller to determine a level of DC current in one or more circuits, and for causing the micro-controller to adjust the one or more EPSs in response to the determined DC current level(s).

8. The system of claim 7, wherein the program causes the micro-controller to adjust the one or more EPSs during turn-on of a load system that draws power from the one or more EPSs.

9. The system of claim 8, wherein the EPSs are controlled by the micro-controller to limit the current supplied to the load systems.

10. The system of claim 8, wherein the adjustments made by the micro-controller are accomplished according to user-defined parameters.

11. The system of claim 7, further comprising a solid-state micro-controller-readable medium having the program stored or embedded thereon.

12. The system of claim 7, wherein the program includes instructions for causing the EPSs to turn on in small increments.

13. The system of claim 12, wherein the increments are selected to limit individual or aggregate load current to levels which are within maximum operating parameters of the EPSs.

14. The system of claim 7, wherein the program includes instructions for causing the micro-controller to control the EPSs in order to keep the power supplied by each EPS to the loads at a safe level.

15. The system of claim 7, wherein the micro-controller can be used to provide power to a single load system or multiple load systems, either via a single EPS or multiple EPSs.

16. The system of claim 7, wherein each EPS has an output electrically connected to a load system, and wherein the micro-controller is programmed to provide instructions to the EPSs to sequentially power individual load systems such that high demand for electricity caused by turning-on a load system is reduced.

17. The system of claim 1, further comprising a printed circuit board and circuit layout which lowers parasitic inductance and increases current throughput.

18. A method of controlling distribution of DC electric power, comprising:
providing one or more electronic power switches (“EPSs”), each EPS having an input terminal and an output terminal, the input terminals being electrically connected to one another;
providing one or more current sensors arranged to monitor electric current supplied by at least one of the EPSs to one or more load systems; and
controlling DC power output from each output terminal using the one or more EPSs.
